(19) United States
(12) Patent Application Publication
(10) Pub. No.: US 2026/0300260 A1
(43) Pub. Date: Oct. 1, 2026

(54) SYNCHRONIZATION OF APPLICATION STATES FOR EXECUTION OF NETWORK OPERATIONS

(71) Applicant: ADP, Inc., Roseland, NJ (US)

(72) Inventors: Anil Kumar Eknath Dhotre, Parsippany, NJ (US); Zafrir Babin, Parsippany, NJ (US); Ajit Kumar, Hyderabad (IN); Vibhor Shukla, Parsippany, NJ (US); Laiyuan Liu, Livingston, NJ (US); Leandro Da Silva Bianchini, Parsippany, NJ (US)

(73) Assignee: ADP, Inc., Roseland, NJ (US)

(21) Appl. No.: 19/633,627

(22) Filed: Mar. 30, 2026

(30) Foreign Application Priority Data
Mar. 31, 2025 (IN) 202511031825

(51) Int. Cl. G06F 16/23

(52) U.S. Cl. CPC G06F 16/2358; G06F 16/2379

(57) ABSTRACT

A system can identify requests to update data records in a database. Each request can include an identifier of a source application and can update a respective data record at a second timestamp, which is subsequent to a first timestamp when the update was applied. The system can establish log entries for the requests in the database. Each log entry can include a timestamp corresponding to a respective request and the source application identifier. The system can determine an active user session with the source application, including a session start time. The system can select a subset of log entries from the database. Each selected log entry can have a timestamp prior to the session start time and an identifier matching the source application. The system can execute a target replay engine to provide updates to the source application to perform a network operation.

### CROSS-REFERENCE TO RELATED APPLICATIONS

This application claims benefit and priority under 35 U.S.C. § 119 to Indian Provisional Patent Application No. 202511031825, filed Mar. 31, 2025, which is hereby incorporated by reference herein in its entirety.

### TECHNICAL FIELD

This application is generally related to computing technology and, more particularly, to synchronizing application states for executing network operations.

### BACKGROUND

Distributed computing systems integrate multiple compute nodes to process data updates and execute corresponding network operations. In such systems, coordinating data updates across multiple applications or services can present challenges related to timing, consistency, or resource usage, which can contribute to errors, delays, or performance inefficiencies.

### SUMMARY

Aspects of the technical solutions described herein address challenges in synchronizing updates to applications or systems to execute network operations across distributed computing systems. Synchronizing applications, such as source applications, with a high volume of data updates (also referred to as data mutations), for example, 100, 1,000, 10,000, 50,000, or more updates per minute, across distributed computing systems for timely execution of network operations can consume significant computing resources and technical challenges. For example, coordinating the process of applying data mutations and the subsequent execution of associated network operations during concurrent updates from multiple data sources across distributed computing systems increases the complexity of maintaining data consistency. Additionally, maintaining the correct sequencing of network operations based on the order of data updates increases computational complexity and introduces the risk of operational inconsistencies. Moreover, scaling the synchronization architecture to accommodate a growing number of source applications that execute network operations based on data updates, along with increasing data volumes, presents challenges related to resource allocation parameters, such as CPU scheduling, memory utilization, and I/O bandwidth. Delays in data mutation processing or replay operations can lead to synchronization mismatches, resulting in outdated application states and delayed network operations. As a result, the lack of a scalable replay architecture in distributed computing systems causes inconsistencies between application states and underlying data, delayed or incorrect network operations, and inefficient resource utilization.

The technical solutions described herein address these and other challenges by implementing a system architecture to synchronize source applications with data updates for executing network operations in distributed computing systems. To do so, the system architecture performs data ingestion and replay operations to record data update requests as log entries in the database, where each log entry includes a timestamp and an identifier of the source application to support data synchronization and system performance. Additionally, the system architecture supports multiple real-time or near real-time data sources, including a cloud-based object storage system for large scale data ingestion (e.g., 1,000, 10,000, 100,000, or more records, files, or events) and a distributed streaming system for real-time events. The system architecture monitors and captures data updates using techniques such as change data capture (CDC) or data update requests through streaming protocols. The system architecture executes a target replay engine to coordinate the replay of data updates from streaming sources by adjusting offsets or from storage-based sources by accessing timestamp indexed files to extract relevant updates. For storage-based replay, a metadata store (e.g., a timestamp indexed database or distributed cache) organizes CDC file indexing to facilitate efficient access within the specified replay window.

In streaming-based replay, offset management controls access to data records within the streaming timeline. Offset management refers to the process of tracking and manipulating the position within a continuous stream of data. Each data record in a streaming system is assigned a sequential offset. The offset management allows the replay engine to specify from which point in the stream it intends to begin reading data updates. By adjusting such offsets, the replay engine can effectively rewind or fast forward through the stream to extract the set of updates relevant to a given replay operation, such that data updates are extracted accurately for network operations. For example, the data mutations are transmitted to the source application in a timely manner, causing it to execute network operations based on the updates. The ingestion and replay operations execute asynchronously, supporting independent scaling and resource allocation within distributed computing systems. Additionally, a distributed cache stores session data, including login timestamps, to define the appropriate replay window for processing update events.

The system architecture regulates access to session specific data, including streamed update events, using a session management application programming interface (API) that maintains session states and controls data streaming for authenticated users. The system architecture further incorporates performance monitoring capabilities to track metrics, such as replay duration, latency, and error rates, for data ingestion and replay functions. The system architecture supports vertical scaling for increasing data volumes and horizontal scaling for concurrent source applications and multiple database systems in distributed computing systems. Moreover, the system architecture maintains data consistency between dependent applications and the underlying data store through synchronization protocols by propagating updates via CDC and synchronizing real-time events in streaming systems to provide updates within defined synchronization intervals. Additionally, the system architecture defines configurable retrieval windows, thereby allowing time bounded access to updates to support the accurate execution of network operations based on operational parameters, including the type of network operation being performed.

In certain cases, the system reconstructs application state transitions through replay intervals associated with authenticated session start times and through selection of replay components having execution characteristics corresponding to the source application. Rather than reprocessing a generic set of stored update events, the system constrains the replay process according to session context and application specific replay handling parameters. The system uses authenticated session information to define replay intervals, reduce timing conflicts between delayed data updates and real-time network operations, maintain deterministic ordering of replayed updates, and improve responsiveness under high volume change data capture workloads. The system also supports isolated reconstruction of application state for concurrent sessions across multiple source applications, while permitting independent scaling of replay resources and delivery of updates according to session specific execution conditions.

Furthermore, the system alters the retrieval behavior and execution behavior of the replay pipeline based on authenticated session context. For example, instead of propagating update events according to event occurrence time, the system identifies a replay interval relative to a session start time, retrieves updates corresponding to the interval, and provides the retrieved updates using a replay engine selected for the source application. The system uses session context as a control input for replay selection and timing and thereby modifies the operation of the replay process, including which updates the system retrieves, the order in which the system processes the updates, and the manner in which the system provides the updates for execution of a network operation. As a result, the technical solutions described herein provide a scalable and robust framework for synchronizing source applications with data updates to support execution of network operations across distributed computing systems.

An aspect of the technical solutions described herein is directed to a system. The system includes one or more processors coupled with memory. The system can identify a plurality of requests to update one or more data records in a database. Each request can include an identifier of a source application and can update a respective data record at a second timestamp. The second timestamp can be subsequent to a first timestamp at which the update was applied to the respective data record. The system can establish, in the database, log entries for the plurality of requests. Each log entry can include a timestamp corresponding to a respective request and the identifier of the source application. The system can determine an active user session associated with the source application. The active user session can be associated with a session start time. The system can select, from the database, a subset of log entries from a plurality of log entries. Each log entry of the subset of log entries can have the timestamp prior to the session start time and the identifier matching the source application. The system can execute a target replay engine to provide, to the source application, during the active user session, updates associated with the subset of log entries to cause the source application to perform a network operation based on the updates.

The system can establish each log entry based on the timestamp corresponding to receipt of the respective request. The system can establish each log entry based on the timestamp corresponding to initiation of the respective request by the source application. The update can include at least one of a generation, a modification, or a deletion of the respective data record. The system can select the target replay engine for the active user session based on the identifier of the source application. The system can determine a plurality of active user sessions associated with the source application based on a plurality of indications, where each of the plurality of indications can correspond to a respective active user session. The system can execute a plurality of target replay engines. Each target replay engine can provide, to the source application associated with the respective active user session, the updates associated with a respective subset of log entries. The system can execute the plurality of target replay engines based on a number of active user sessions exceeding a threshold. The system can execute the plurality of target replay engines based on resource utilization associated with at least one target replay engine exceeding a utilization threshold. The system can dynamically adjust resource allocation among the plurality of target replay engines based on the resource utilization associated with the at least one target replay engine exceeding the utilization threshold. The system can determine the active user session via a login application programming interface. The system can receive the plurality of requests via a real time data source. The system can store the log entries in a cloud-based storage system.

An aspect of the technical solutions described herein is directed to a method. The method can include identifying, by one or more processors, coupled with memory, a plurality of requests to update one or more data records in a database. Each request can include an identifier of a source application. The method can include establishing, by the one or more processors, in the database, log entries for the plurality of requests. Each log entry can include a timestamp corresponding to a respective request and the identifier of the source application. The method can include determining, by the one or more processors, an active user session associated with the source application. The active user session can be associated with a session start time. The method can include filtering, by the one or more processors, from the database, a subset of log entries. Each log entry of the subset of log entries can have the timestamp prior to the session start time and the identifier matching the source application. The method can include executing, by the one or more processors, a target replay engine to present updates associated with the subset of log entries to cause the source application to perform, during the active user session, a network operation.

The method can include establishing, by the one or more processors, each log entry based on the timestamp corresponding to receipt of the respective request. The method can include establishing, by the one or more processors, each log entry based on the timestamp corresponding to initiation of the respective request by the source application. The update can include at least one of a generation, a modification, or a deletion of the respective data record. The method can include selecting, by the one or more processors, the target replay engine for the active user session based on the identifier of the source application. The method can include determining, by the one or more processors, a plurality of active user sessions associated with the source application based on a plurality of indications, where each of the plurality of indications can correspond to a respective active user session. The method can include executing, by the one or more processors, a plurality of target replay engines. Each target replay engine can provide, to the source application associated with the respective active user session, the updates associated with a respective subset of log entries. The method can include executing, by the one or more processors, the plurality of target replay engines based on a number of active user sessions exceeding a threshold.

An aspect of the technical solutions described herein is directed to a non-transitory computer readable medium, including one or more instructions stored thereon and executable by a processor. The processor can identify a plurality of requests to update one or more data records in a database. Each request can include an identifier of a source application and can update a respective data record. The processor can establish, in the database, log entries for the plurality of requests. Each log entry can include a timestamp corresponding to a respective request and the identifier of the source application. The processor can determine an active user session associated with the source application. The active user session can be associated with a session start time. The processor can select, from the database, a subset of log entries from a plurality of log entries. Each log entry of the subset of log entries can have the identifier matching the source application and the timestamp within a predetermined relationship to the session start time. The processor can execute a target replay engine to provide, to the source application, updates associated with the subset of log entries to cause the source application to perform a network operation based on the updates.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, this innovation is not limited to any figure or portion thereof depicted or referenced herein, or any aspect described herein with respect to any figures depicted or referenced herein.

FIG. 1 depicts an example system to provide synchronization of application states for executing network operations, in accordance with some implementations.

FIG. 2 depicts an example operational system, in accordance with some implementations.

FIG. 3 depicts an example method flow diagram for synchronizing application states for executing network operations, in accordance with some implementations.

FIG. 4 depicts a block diagram of an example computing system for implementing the embodiments of the present solution, including, for example, the systems depicted in FIG. 1-2, and the method depicted in FIG. 3.

### DETAILED DESCRIPTION

Aspects of the technical solutions are described herein with reference to the figures, which are illustrative examples of this technical solution. The figures and examples below are not meant to limit the scope of the technical solutions to the present implementations or to a single implementation. Several other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

The technical solutions described herein facilitate application state synchronization to support network operation execution in distributed computing environments by processing and replaying data updates. The system identifies multiple requests to update one or more data records in a database. Each request can include a source application identifier and indicate an update to a respective data record at a second timestamp, which is subsequent to a first timestamp when the update was applied to the data record. The system establishes log entries for these requests in the database, with each log entry including the timestamp associated with the respective request and the source application identifier. The system receives an indication of an active user session associated with the source application, including a session start time. The system then retrieves a subset of log entries from the database, where each selected log entry has a timestamp earlier than the session start time and an identifier matching the source application. The system executes a target replay engine to provide data updates, associated with the subset of log entries, to the source application during the active user session. These updates cause the source application to perform network operations based on the replayed data. The computing architecture, thus, facilitates data consistency and timely network operation execution based on data updates. As such, the technical solutions described herein are rooted in computing technology. The technical solutions described herein provide improvements to computing technology.

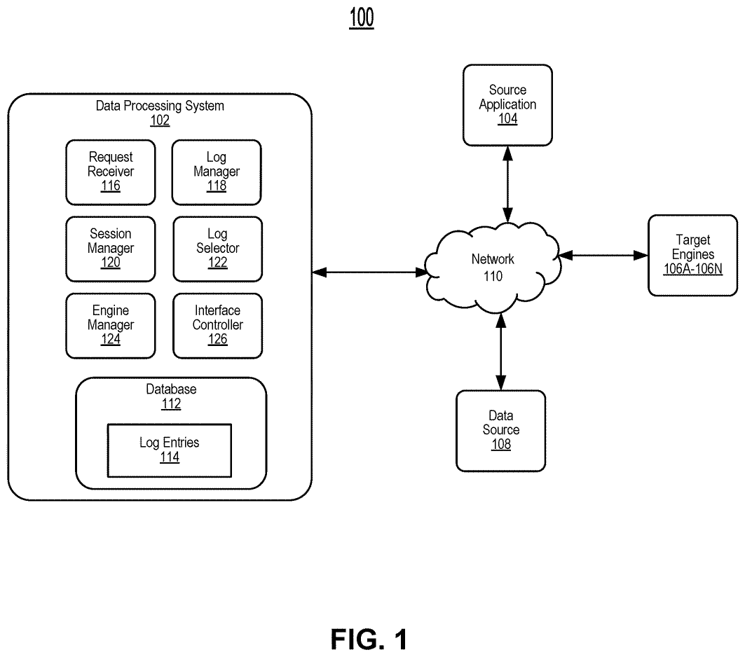

FIG. 1 depicts an example system according to one or more aspects of the technical solutions described herein. As illustrated by way of example in FIG. 1, a system 100 can include one or more of a data processing system 102, a source application 104, a target engine 106, and a data source 108. One or more components of the system 100 can communicate via network 110.

The data processing system 102 (also referred to herein as a replay system 102) can include one or more computing devices to process and replay data updates. Data updates can refer to changes or modifications to data records, such as transactional data modifications (e.g., database transactions), state changes (e.g., application configuration updates), and streamed data updates (e.g., real-time data feeds), among others. Replay can refer to reprocessing data updates to synchronize or propagate data changes to applications and services, such that target applications or systems can perform network operations based on the updated data. The data updates can originate from various sources and can trigger different actions within system 100. For example, a data update can result from the execution of new data programs, which may ingest external data, perform calculations, or generate new data requiring tracking and replay for synchronization. In this context, the data update can specify the output or effect of the program's execution, which is tracked and replayed to maintain data consistency. Data updates can also be initiated by existing programs, such as batch processes, scheduled tasks, or user triggered applications, with the update specifying changes to data records made during program execution. Such changes may be replayed to other systems or applications to maintain synchronized operations. Additionally, the data processing system 102 can generate data updates during replay operations by replaying previously recorded updates. The replayed updates can correspond to original changes and are applied to target applications or systems to support network operations.

The data processing system 102 (or the replay system 102) can maintain a record of data updates by using pointers instead of storing complete data records to minimize storage overhead. These pointers can reference metadata, such as the filename and timestamp of data generation or modification, along with additional attributes, such as a separate log entry or column indicating the generation time of the update. The data processing system 102 can parse, validate, and transform data updates to maintain data integrity and compatibility with dependent applications. The data processing system 102 can support customizable replay configurations, such as time bounded replay windows, selective data filtering, and offset-based synchronization, among others. The data processing system 102 can transmit and receive information from various components, such as the source application 104, the target engine 106, and the data source 108, for data synchronization and replay operations. The data processing system 102 can manage the deployment and configuration of interdependent computational components. The data processing system 102 can perform data mapping and parameter translation between heterogeneous engines. The data processing system 102 can maintain hierarchical relationships and dependencies across multi-layered configuration settings to maintain the integrity of data processing workflows.

The data processing system 102 (or the replay system 102) can be configured for high throughput and low latency data update replay. The data processing system 102 can attain a service level objective with a 90th percentile response time of less than a designated period (e.g., 30 seconds) while processing a sustained throughput of 450 records per second, for example. The data processing system 102 can maintain the corresponding performance characteristics under concurrent producer loads (e.g., 6 concurrent producers, such as multiple front end applications initiating data updates based on user input, various background processes performing data transformations, or several internal system services signaling state changes to other components) to preserve consistent throughput and latency. A producer load can refer to the rate at which a data source generates and sends data updates to the system, while concurrent can refer to multiple data sources generating and sending updates simultaneously. In certain cases, the data processing system 102 can demonstrate performance characteristics under a moderate load, with a sustained throughput of approximately 200 records per second generated by 6 concurrent producers. Under such conditions, and with 6 concurrent client interactions, the data processing system 102 can achieve an average latency of less than 2 minutes, for example.

The data processing system 102 (or the replay system 102) can be deployed in various configurations. The data processing system 102 can include a physical computer system operatively coupled or couplable with one or more components of the system 100. The data processing system 102 can include, host, or be hosted by or on a cloud system, a server, a distributed remote system, or any combination thereof. The data processing system 102 can include a virtual computing system, an operating system, and a communication bus to effect communication and processing. The data processing system 102 can include physical infrastructure, such as physical servers, storage devices, and network equipment housed in data centers. The data processing system 102 can include a virtual computing system, which can include cloud-based virtual machines or containers for running applications and services. The data processing system 102 can include an operating system that can function as the core manager, allocating resources, configuring processes, and maintaining seamless interaction between hardware and applications. The operating system can be a general-purpose operating system or a specialized operating system configured for data processing and replay. The data processing system 102 can include a communication interface, which can be implemented using a communication bus, network interfaces, or a combination thereof. The communication interface can facilitate communication between different components within the data processing system 102. The data processing system 102 can connect or interface with external systems to allow for data exchange and service delivery across applications and services.

The source application 104 can be or include any script, file, program, application, set of instructions, or computer-executable code that can perform a network operation. The source application 104 can refer to one or more applications to process data updates. The source application 104 can include applications that generate data update requests or applications that execute network operations based on those requests. The source application 104 can initiate data update requests. For example, the source application 104 can generate data update requests based on a user-initiated action (e.g., submitting a data modification via a user device) or a system-triggered event (e.g., an automated task or scheduled operation). The source application 104 can be a target application that, due to data synchronization logic, can be intended to receive and process data updates. For example, in distributed systems, certain applications may consume data updates that are distributed or propagated across networked nodes. The source application 104 can receive and apply data updates by executing network operations. A network operation can correspond to a range of functions, such as payroll processing, benefits administration, human resources management, and other processes. For example, the network operation can include managing and automating data and workflows associated with a computing infrastructure.

The source application 104 can be a software system to manage and automate various data flows and operations. For example, the source application 104 can be a system used by a payroll service provider to manage employee payroll data (including salary, deductions, and tax withholdings), generate paychecks, and file payroll taxes, among others. The source application 104 can be a benefits administration system used by a benefits provider to manage employee benefits enrollment, track benefits usage, and process claims, among others. The source application 104 can be a human capital management (HCM) system used by a human resource (HR) service provider to manage employee records, track employee performance, and administer employee onboarding and offboarding, among others. The source application 104 can manage various functions, such as data entry, calculations, reporting, or integration with other systems. The specific functionalities associated with the source application 104 can vary depending on the implementation. The source application 104 can include an application executing on a client device. The source application 104 can include or correspond to a web application, a server application, a resource, a desktop, or a file. The source application 104 can include a local application (e.g., local to a client system), a hosted application, a software-as-a-service (SaaS) application, a virtual application, a mobile application, and other forms of content. The source application 104 can include or correspond to applications provided by remote servers or third party servers.

The system 100 can utilize, implement, or interface with one or more target engines 106A-106N (also referred to herein as a target engine 106 or a target replay engine 106). Each target engine 106 can include one or more computing components, which can be or include any script, file, program, application, set of instructions, or computer-executable code to provide data updates to source applications 104 for initiating network operation execution. The target engine 106 can receive data updates associated with log entries from the data processing system 102 that originate from various sources, including databases, message queues, and streaming platforms, among others. The target engine 106 can transform or format the data updates into a structure compatible with a specific source application 104. For example, the target engine 106 can implement data mapping, type conversions, or schema adjustments. The target engine 106 can utilize various communication protocols to transmit data updates during active user sessions to the source application 104, including, but not limited to, direct network connections, message queues, application programming interfaces (APIs), or remote procedure calls (RPCs). The target engine 106 can manage the timing and delivery of updates, which can include batching multiple updates for efficiency or prioritizing updates based on their importance or urgency. The target engine 106 can process various types of data updates, such as insertions, deletions, or modifications to data records. The target engine 106 can incorporate error handling and retry mechanisms to facilitate reliable delivery of data updates.

The target engine 106 can execute replay logic based on session associated context received from the data processing system 102. For example, the target engine 106 can receive replay input corresponding to a source application identifier, a session start time, and a set of log entries 114 retrieved for a replay window associated with the active user session. The target engine 106 can order the log entries 114 according to a deterministic ordering rule, such as timestamp order, offset order, sequence order, or a composite ordering rule, and can apply one or more transformation operations, such as schema mapping, field translation, filtering, validation, deduplication, or format conversion. The target engine 106 can provide the resulting updates to the source application 104 using one or more communication mechanisms, such as an application programming interface, a message queue, a remote procedure call interface, or another network communication channel compatible with the source application 104.

The target engine 106 can be deployed in different environments. The target engine 106 can be implemented internally within the data processing system 102. In certain cases, the target engine 106 can be implemented externally to the data processing system 102 and can be accessed via the network 110. In certain cases, the target engine 106 can run on the same server as the source application 104. In certain cases, the target engine 106 can be deployed on a separate dedicated server. The target engine 106 can support horizontal and vertical scaling. Horizontal scaling can include adding more instances of the target engine 106, and vertical scaling can include increasing the resources (e.g., CPU, memory) allocated to each instance. The target engine configuration can vary, with the target engine 106 corresponding to one or more instances based on implementation or the type of source application 104 that executes network operations.

The target engine 106 can provide variable performance levels depending on the type of executable program. In this regard, target engine instances 106 can be configured for different execution contexts. For example, certain target engines 106 can process real-time data updates, while other target engines 106 can process previously recorded batch updates. Within a single target engine instance, resource prioritization techniques can be used to dynamically allocate system resources according to execution requirements. For example, replay programs can be prioritized for CPU cycles and memory bandwidth allocation. The target engine 106 can implement configurable execution profiles directed to specific program types. These profiles can specify performance parameters, including buffer allocation thresholds, cache management policies, and other performance settings. The target engine 106 can dynamically switch between these profiles in response to the type of program under execution.

The target engine 106 can replay data updates to a user interface on a user device (e.g., a web application or mobile app), such that the user can confirm or review the updates during active user sessions. An active user session can correspond to a period of time during which a user device is authenticated and actively interacting with the source application 104, while an inactive user session can refer to a period when the user device is not authenticated with the source application or when there is no active interaction occurring (e.g., because of user inactivity, session timeout, user logout, or application closure). The active user session can specify that the user device is actively using the application's features and resources. The target engine 106 can send the replayed data to an intermediate presentation layer, such as a web server, mobile application, or dedicated user interface service, that can render the data on the user interface. The presentation layer can display the updates and capture user confirmation events. The target engine 106 can instruct the source application 104 to execute a corresponding network operation once confirmation is received. The target engine 106 can support asynchronous confirmation by presenting the replayed data on the user interface and allowing the user to confirm the update at a later time. The target engine 106 can store pending updates and apply them after confirmation. The target engine 106 can also batch multiple replayed updates and present them to the user for group confirmation.

The data source 108 can include a wide range of systems, such as computing systems, servers, databases, data warehouses, message queues, streaming platforms, file systems, cloud-based storage systems, or distributed file systems. The data source 108 can be implemented using hardware, software, or a combination of both. The data source 108 can be accessible via the network 110 to facilitate communication with other components of the system 100. The data source 108 can receive data updates from various sources, including APIs, web scrapers, and third party data providers (e.g., data aggregation platforms). The data source 108 can provide data updates in various forms and formats, including transactional data, change data capture (CDC) streams, event streams, and snapshots of data. The data source 108 can store data in various formats, such as relational tables, NoSQL documents, or log files. In certain cases, data preprocessing, such as normalization or encoding, may occur at edge locations (e.g., client servers, data entry points, or gateway devices) before data updates are transmitted to the data source 108. The data source 108 can store the preprocessed updates and expose them for retrieval and replay operations by the data processing system 102.

The data source 108 can be a real-time data source, providing a continuous stream of updates as they occur. The data source 108 can be a historical data repository, storing a record of past updates. The data source 108 can be managed by a database management system or other data management software. The type and implementation of the data source 108 can be determined by system demands and the characteristics of the data being processed. For example, a system managing high volume, real-time data updates (e.g., 100, 1,000, 10,000, 50,000, or more updates per minute) can utilize or interface with a distributed database or a message streaming platform. A system processing infrequent batch updates can depend on a relational database or a cloud-based object storage solution. The selection of the data source 108 can depend on factors such as data format (e.g., structured, semi-structured, or unstructured), data access patterns (e.g., read intensive or write intensive), consistency protocols, and resource optimization considerations.

The network 110 can include any type or form of network. The geographical scope of the network 110 can vary widely, and the network 110 can include a body area network (BAN), a personal area network (PAN), a local-area network (LAN), e.g., Intranet, a metropolitan area network (MAN), a wide area network (WAN), or the Internet. The topology of the network 110 can be of any form and can include, e.g., any of the following: point-to-point, bus, star, ring, mesh, or tree. The network 110 can include an overlay network that is virtual and sits on top of one or more layers of other networks 110. The network 110 can be of any such network topology as known to those ordinarily skilled in the art capable of supporting the operations described herein. For example, the network 110 can be any form of computer network that can relay information among the data processing system 102, the source application 104, the target engine 106, and the data source 108. The network 110 can utilize different techniques and layers or stacks of protocols, including, e.g., the Ethernet protocol, the Internet protocol suite (TCP or IP), the ATM (Asynchronous Transfer Mode) technique, the SONET (Synchronous Optical Networking) protocol, or the SD (Synchronous Digital Hierarchy) protocol. The TCP or IP Internet protocol suite can include the application layer, transport layer, Internet layer (including, e.g., IPv6), or the link layer. The network 110 can include a type of broadcast network, a telecommunications network, a data communication network, or a computer network.

The data processing system 102 can include, interface with, communicate with, or otherwise utilize a database 112. The database 112 can be a computer-readable memory that can store or maintain any of the information described herein. The database 112 can store data associated with the system 100. The database 112 can include one or more hardware memory devices to store binary data, digital data, or the like. The database 112 can include one or more electrical components, electronic components, programmable electronic components, reprogrammable electronic components, integrated circuits, semiconductor devices, flip flops, arithmetic units, or the like. The database 112 can include at least one of a non-volatile memory device, a solid-state memory device, a flash memory device, or a NAND memory device. The database 112 can include one or more addressable memory regions disposed on one or more physical memory arrays. A physical memory array can include a NAND gate array disposed on, for example, at least one of a particular semiconductor device, an integrated circuit device, or a printed circuit board device. The database 112 can correspond to a non-transitory computer readable medium. The non-transitory computer readable medium can include one or more instructions executable by any component of the data processing system 102.

The database 112 can store or maintain one or more data structures, which can include containers, indices, or otherwise store each of the values, pluralities, sets, variables, vectors, numbers, or thresholds described herein. The database 112 can utilize columnar storage databases or in-memory data grids for high speed data access and processing, such as processing 100, 1,000, 10,000, or more records per second with low latency retrieval. The database 112 can be accessed using one or more memory addresses, index values, or identifiers of any item, structure, or region maintained in the database 112. The database 112 can be accessed by the components of the data processing system 102, the source application 104, the target engine 106, the data source 108, or any other computing device described herein, via the network 110. The database 112 can be internal to the data processing system 102. The database 112 can exist external to the data processing system 102 and can be accessed via the network 110. For example, the database 112 can be distributed across many different computer systems (e.g., a cloud computing system) or storage elements and can be accessed via the network 110 or a suitable computer bus interface.

The database 112 can store or maintain one or more log entries 114. A log entry 114 can specify a structured record of an operation, event, or transaction related to data updates. In this regard, an operation, event, or transaction can refer to the creation of a new record, the modification of an existing record, or the deletion of a record in the data managed by the database 112 or the data processing system 102. The log entry 114 can include a timestamp indicating the time of the operation, event, or transaction that resulted in the data update. The timestamp can be the time the data update was initiated by a source application 104, the time the data update was intercepted by the data processing system 102, or both. The log entry 114 can include an identifier of the source application 104 that initiated the operation or event to track updates originating from different applications. A log entry 114 can include identifiers of specific data records within the database 112 that were created, modified, or deleted. A data record can refer to a discrete unit of data within a database or storage system, such as a row in a relational database table, a document in a NoSQL database, a record in a file, or an object in an object store. The data record can include various types of information depending on the application. For example, in an HCM system, a data record can store information about a profile data structure, including identifiers such as employee ID or profile ID, along with other details such as name, job title, contact information, employment history, and activity logs, among others.

For data updates, the log entry 114 can include the before and after values of the modified data to facilitate forward and backward tracking of updates. The log entry 114 can specify a request to update one or more data records, such as an insertion, deletion, or modification. The log entry 114 can specify the type of update operation (e.g., insert, update, delete). The log entry 114 can be part of a sequence of log entries 114 that capture a history of changes to data over time, forming a change log or transaction log. The log entry 114 can be used for various purposes, including auditing (tracking who made what changes and when), recovery (restoring the database to a consistent state after a failure), and replay (reapplying changes to synchronize data across systems or applications), among others. In certain cases, the log entry 114 can be generated based on change data capture (CDC) metadata, including file names that encode information about captured changes. The CDC metadata can reference specific data records or batches of data records that have been modified. The CDC file names can follow naming conventions that incorporate timestamps, sequence numbers, or other identifiers to facilitate traceability of the changes.

The log entry 114 can be stored in the database 112 or other storage system, such as a log storage system, distributed cache, or cloud-based storage service, depending on the implementation. The database 112 or storage system can facilitate efficient writing and retrieval of log entries 114 based on factors such as log entry volume, write and read frequency, data durability, availability, and performance requirements (e.g., latency and throughput). The database 112 can support various query patterns, such as retrieving log entries 114 within a specific time range, retrieving log entries 114 associated with a particular source application 104, or retrieving entries based on other criteria. The database 112 can implement data lifecycle management mechanisms, such as archiving or deleting older log entries 114 to maintain storage capacity.

The data processing system 102 can include, interface with, communicate with, or otherwise utilize a request receiver 116. The request receiver 116 can be or include any script, file, program, application, set of instructions, or computer-executable code that can receive and process requests related to data updates or replay operations. The request receiver 116 can receive requests from various sources, including source applications 104, data sources 108, administrative interfaces, or other systems. The request receiver 116 can receive update and replay requests from a real-time data source 108, such as a distributed streaming platform. The streaming platform can provide continuous streams of data changes as structured message streams. The request receiver 116 can subscribe to data streams within the real-time data source 108 to receive messages as they are generated. Each message can specify or encode a data update request.

The requests received by the request receiver 116 can be or include requests to update data records, requests to initiate or control replay operations, or requests to query the status of the data processing system 102. The request receiver 116 can support various communication protocols for receiving requests, including HTTP/HTTPS (e.g., used in web APIs, such as REST APIs), message queues, gRPC (gRPC Remote Procedure Call), or other custom protocols. The communication protocol gRPC can refer to or include a cross-platform, high performance remote procedure call framework, which can connect services in a microservices architecture or connect mobile device clients to backend services, for example. The request receiver 116 can validate incoming requests by identifying parameters, verifying data types, and authenticating the request source, such as a client application, API client, external system, or user device. The request receiver 116 can parse and interpret the received requests to extract relevant data for processing. The request receiver 116 can transform the requests into an internal format compatible with the data processing system 102. The request receiver 116 can facilitate communication by transmitting the processed requests to other components of the data processing system 102 for further operations. The request receiver 116 can manage concurrent requests from multiple sources. The request receiver 116 can be deployed as a standalone service, integrated within the data processing system 102, or distributed across multiple nodes.

The request receiver 116 can identify a plurality of requests to update data records within the database 112. The request receiver 116 can monitor logs maintained within the database 112 to track changes. When a data update occurs, the database 112 can generate a log entry recording the details of the update. The request receiver 116 can read these logs to identify updates. The request receiver 116 can utilize or implement CDC tools or services to detect and capture modifications to data records within the database 112. The request receiver 116 can receive data updates from source applications 104 that send update requests to the data processing system 102. The identified requests can include operations, such as generating, modifying, or deleting data records. Each request can include an identifier of the source application 104 that initiated the change. For example, an update request initiated by an HCM application related to an employee's updated salary can include the identifier of the HCM application.

The requests received by the request receiver 116 can indicate a pending update to a respective data record by referencing a subsequent timestamp, which specifies the intended or target time for the update to take effect. The subsequent timestamp can specify when the update was received by the data processing system 102 or initiated by the source application 104. The subsequent timestamp can be later than the actual application timestamp, which records when the database 112 was updated with a previous version of the same or a similar update. The actual application timestamp can correspond to when the database 112 is updated with a change, and the subsequent timestamp can specify the intended execution time of the update, as defined by the source application's logic. In certain cases, a request can indicate that a respective data record is to be updated at a second timestamp that is subsequent to a first timestamp at which an update to the respective data record was applied. For example, an HR manager may approve the promotion of an employee at 10:00 am, resulting in a salary increase within an HCM system. The HCM system records the approval in the database 112, with the approval event timestamped at 10:00 am. However, according to organizational policy, the promotion and salary increase may be scheduled to be applied at the beginning of the subsequent business day (e.g., 9:00 am), which can correspond to a subsequent timestamp. The request receiver 116 can identify such pending updates by comparing the approval event timestamp (10:00 am) with the subsequent timestamp (9:00 am the next day). The difference between these timestamps can indicate that the update, while approved and recorded, has not yet been applied.

The data processing system 102 can include, interface with, communicate with, or otherwise utilize a log manager 118. The log manager 118 can be or include any script, file, program, application, set of instructions, or computer-executable code that can establish and manage log entries 114. The log manager 118 can establish log entries 114 in response to various triggers. For example, the log manager 118 can generate a log entry 114 upon receiving a request to update data records. The log manager 118 can generate a log entry 114 based on an event, such as the modification of a data record in the database 112. The log manager 118 can associate a timestamp with each log entry 114. The timestamp can correspond to the time the request was received by the data processing system 102 from the source application 104, the time the request was initiated by the source application 104, or the time the update was applied to the database 112. The log manager 118 can use any of these timestamps, or a combination thereof, depending on the specific demands of the data processing system 102. The log manager 118 can include an identifier of the source application 104 that initiated the request in the log entry 114.

The source application 104 can include a timestamp indicating its local initiation time within the update request. The request receiver 116 can extract the timestamp and provide it to the log manager 118 for inclusion in the log entry 114. The source application 104 can transmit the initiation timestamp as part of metadata associated with the update request. The metadata can be included in headers of an API call, within a message header, or through another communication channel. The request receiver 116 can correlate the metadata with the corresponding update request and provide the initiation timestamp to the log manager 118 for inclusion in the log entry 114. The source application 104 can generate a correlation ID when initiating an update request and record its local initiation timestamp along with the ID. The correlation ID can be included in the update request transmitted to the data processing system 102. The log manager 118, upon receiving the request via the request receiver 116, can use the correlation ID to query a dedicated timestamp service or a shared data store to retrieve the initiation timestamp recorded by the source application 104 for inclusion in the log entry 114.

The log manager 118 can generate or update the log entry 114 with a timestamp corresponding to the time the request was received by the data processing system 102 from the source application 104. In such embodiments, the timestamp can be recorded by the data processing system 102 via the request receiver 116 upon receipt of the update request and can be used by the log manager 118 when generating or updating the log entry 114. The log entries 114 can include additional information, such as the type of update operation (insert, update, delete), the data record identifiers affected by the update, the before and after values of the data (for updates), transaction IDs, user IDs, or other relevant metadata.

The log manager 118 can store the log entries 114 in various storage systems. For example, the log manager 118 can store log entries 114 in the database 112, in a separate log storage system for high volume write operations and sequential access patterns, or in a distributed cache for faster retrieval. The log manager 118 can store the log entries 114 in a cloud-based storage system for scalability and durability. The log manager 118 can interact with cloud storage services through APIs or other interfaces to store and retrieve log entries 114. The log manager 118 can facilitate the retrieval and organization of log entries 114 based on various criteria, such as timestamp ranges, source application identifiers, or other relevant attributes. The log manager 118 can implement log rotation or archiving policies to manage storage space. The log manager 118 can provide functionalities for query execution, data filtering, and processing of log entries 114.

The data processing system 102 can include, interface with, communicate with, or otherwise utilize a session manager 120. The session manager 120 can be or include any script, file, program, application, set of instructions, or computer-executable code that can manage and track user sessions associated with source applications 104. A user session can correspond to a period of interaction between a user device (e.g., including a computer, mobile device, or other network connected system) and the source application 104. The user session can begin with an authentication process (e.g., login) and end with a logout or session timeout. The user session can include activities performed by the user device within the source application 104 during that time period. For example, the user session can include data entered, actions performed, resources accessed, and contextual information about the user's interaction. The session manager 120 can receive notifications or updates regarding active user sessions associated with the source application 104. The session manager 120 can receive an indication of an active user session through various protocols, including a login application programming interface (API), an authentication token, or other session management protocols.

The session manager 120 can determine an active user session by querying or monitoring the source application 104 or an associated authentication service to identify the status of active user sessions. For example, the session manager 120 can implement periodic polling of an API endpoint, subscribing to session related events, or evaluating network traffic for session identifiers to determine active user sessions. In certain cases, the session manager 120 can determine a plurality of active user sessions associated with the source application 104 based on a plurality of indications, where each indication corresponds to a respective active user session. When a new session identifier is received by the session manager 120 via a login API call to the data processing system 102 or through direct communication from an authentication service, the session manager 120 can determine a new active user session. The session manager 120 can then add the corresponding identifier (or a derived representation of the session, including user ID and session start time) to its session registry. Each entry in the session registry corresponds to an indication of an active user session.

The active user session can be associated with a session start time. The session start time can correspond to a timestamp captured when the user device successfully authenticates and establishes a connection with the source application 104. The active user session may continue until the user device logs out, the session times out due to inactivity, or the application terminates. The session manager 120 can maintain session specific context information, including attributes such as user ID, roles, permissions, and other relevant metadata. The session manager 120 can manage a large number of concurrent active user sessions. For example, the session manager 120 can use session indexing, caching mechanisms, or distributed session management techniques to manage high session volumes. The session manager 120 can track session state, monitor user activity, or apply policies such as session expiration, re-authentication requirements, or dynamic access control adjustments.

The session manager 120 can normalize the session start time before the session start time is used for replay selection. For example, the session manager 120 can synchronize the session start time using a shared timing source, translate the session start time into a normalized system time format, or convert the session start time into a logical clock value, sequence value, or offset representation. Such normalization can facilitate consistent comparison between session timing information and timestamps, offsets, or sequence identifiers associated with log entries 114 collected or acquired from distributed components of the system 100.

The data processing system 102 can include, interface with, communicate with, or otherwise utilize a log selector 122. The log selector 122 can be or include any script, file, program, application, set of instructions, or computer-executable code that can retrieve and filter relevant log entries 114 from the database 112. The log selector 122 can interact with various data sources 108, such as log files, distributed streaming platforms, databases, and cloud-based storage systems. The log selector 122 can utilize query languages or APIs specific to each data source to retrieve log entries 114. The log selector 122 can provide the filtered log entries 114 to other components of the data processing system 102 for further processing. The log selector 122 can support the integration of additional data sources or the implementation of new filtering criteria.

The log selector 122 can select log entries 114 based on a combination of recorded timestamps and source application identifiers. The log selector 122 can receive information about the active user session, including the session start time and the identifier of the source application 104 associated with the active user session. The log selector 122 can filter log entries 114 based on their recorded timestamp. The log selector 122 can select log entries 114 whose recorded timestamp is prior to the provided session start time, such that log entries 114 specifying events or pending updates that occurred before the user session began are selected. The log selector 122 can further filter the log entries 114 based on the source application identifier. For example, the log selector 122 can select those log entries 114 whose recorded source application identifier matches the identifier of the source application 104 associated with the active user session, such that log entries 114 related to the specific application are selected.

The log selector 122 can filter log entries 114 based on source application identifiers and recorded timestamps that satisfy a predetermined relationship relative to session start times associated with active user sessions. The relationship between the log entry timestamp and the session start time can determine which log entries 114 are selected. For example, the log selector 122 can filter log entries 114 whose recorded timestamp falls within a specific time window relative to the session start time. The time window can be a time period before the active user session began, during the active user session, or a combination of both. Additionally, the log selector 122 can select log entries 114 where the source application identifier in the log entry 114 matches the identifier of the source application 104 associated with the active user session. The log selector 122 can select log entries 114 for a specific source application that occurred before or during a given session start time to capture relevant events. The events can include data changes made during the session or updates relevant to the session that occurred before the session began.

The log selector 122 can define replay selection based on authenticated session context rather than retrieving a general set of update events for reprocessing. For example, the log selector 122 can receive a source application identifier and a session start time associated with an active user session and can determine one or more replay window boundaries relative to the session start time. Based on such replay window boundaries, the log selector 122 can retrieve log entries 114 for use in reconstruction of state transitions for the source application 104 during the active user session. The data processing system 102 can, in response to binding replay selection to session context, coordinate delayed data mutations, updates, or changes with network operations initiated during the active user session and can reduce retrieval of unrelated updates. In certain cases, the data processing system 102 can use the authenticated session context to modify the operation of the replay pipeline by defining which log entries 114 to retrieve for replay and by constraining replay selection to updates relevant to the active user session.

The log selector 122 can implement various retrieval strategies based on the source of the log entries 114 to retrieve relevant data updates. For streaming sources, such as message queues or real-time data feeds, the log selector 122 can use the stream's data structure. Each log entry within the stream can be associated with an offset, such as a sequential identifier specifying its position in the stream. The log selector 122 can adjust these offsets to access specific log entries or ranges of entries. The log selector 122 can maintain a mapping of timestamps to offsets to facilitate time-based lookups within the data stream. For storage-based sources, such as databases or log files, the log selector 122 can use timestamp indexed files to facilitate efficient retrieval. These indexes can provide a structured mechanism to identify log entries 114 based on their timestamps. The log selector 122 can reference the index to identify files or file sections, including the relevant entries, and directly access the targeted portions of the file. The timestamp index can be implemented as a hash table or another suitable data structure to support low latency lookups. The log selector 122 can integrate timestamp-based filtering with other filtering criteria, such as source application identifiers, to further refine query results.

The data processing system 102 can include, interface with, communicate with, or otherwise utilize an engine manager 124. The engine manager 124 can be or include any script, file, program, application, set of instructions, or computer-executable code that can manage the selection and execution of target engines 106. For example, the engine manager 124 can select and execute one or more target engines 106 for a given replay operation. The engine manager 124 can select the target engine 106 based on various factors, including the identifier of the source application 104 associated with the active user session. The engine manager 124 can receive or retrieve the identifier of the source application 104 associated with the active user session. The engine manager 124 can use the source application identifier to identify the source application 104 that initiated the data update request or is the intended recipient of the replayed updates. The engine manager 124 can maintain a mapping or registry that associates source application identifiers with specific target engines 106. The mapping can be managed through various configurations. For example, an administrator can configure the mapping by specifying the target engine 106 configured for replaying data updates for each source application 104. The engine manager 124 can execute target engines 106 configured for different applications, such as using one target engine 106 for financial applications and another target engine 106 for HR applications, based on differences in data schemas and processing demands. The engine manager 124 can implement rule-based mapping, where target engines 106 are mapped according to the source applications 104 based on predefined naming rules to facilitate the automatic selection of the appropriate target engine 106 using the source application identifier.

In certain cases, the engine manager 124 can select a target engine 106 according to an execution profile associated with the source application 104. The execution profile can specify replay handling characteristics, such as ordering behavior, buffering parameters, transformation rules, delivery protocols, retry behavior, or resource allocation preferences. The data processing system 102 can, in response to selecting a target engine 106 according to execution characteristics associated with the source application 104, provide replay handling adapted to the application type and can improve deterministic reconstruction of application state transitions during active user sessions.

The engine manager 124 can dynamically determine target engine mappings based on various factors, such as system load, engine availability, or the type of operation being requested (e.g., real-time data updates or previously recorded batch updates). The engine manager 124 can use the mapping to identify the appropriate target engine 106 by performing a lookup on the source application identifier. Once the target engine 106 is identified, the engine manager 124 can initiate its execution, which may include starting a new process, launching a container or virtual machine, or allocating computational resources. The engine manager 124 can provide the selected target engine 106 with the context for the replay operation. The context can include filtered log entries from the log selector 122, session context (e.g., user ID, roles, access permissions, and other relevant attributes), and configuration parameters relevant to the target engine 106 or source application 104. The engine manager 124 can instruct the selected target engine 106 to initiate the replay operation. The target engine 106 can process the provided context to execute the replay of data updates in the correct order and for the appropriate source application 104 to facilitate network operation execution.

The engine manager 124 can manage the concurrent execution of target engines 106 to support active user sessions across multiple source applications 104. In certain cases, each target engine 106 can be assigned to a respective active user session and can provide updates associated with a respective subset of log entries selected for that active user session. The engine manager 124 can receive indications of active user sessions from the session manager 120 or other components of the system 100. The indications can include metadata, such as session IDs, user IDs, source application identifiers, and session start times, among others. The engine manager 124 can monitor the number of active user sessions and dynamically adjust the number of active target engines 106 to accommodate changes in workload demand. The engine manager 124 can implement a scalable resource allocation mechanism based on predefined thresholds. The threshold can specify a limit at which the current number of active replay engines 106 is considered insufficient to process the incoming workload of active user sessions. When the number of active user sessions exceeds the threshold (e.g., 50, 100, 500, or more active user sessions), the engine manager 124 can initiate the execution of additional target engines 106 to distribute the processing load. The engine manager 124 can determine the appropriate target engine 106 based on various factors, such as the source application associated with the active user session, the type of data being replayed, and the system's current load conditions, among others.

The engine manager 124 can assign replay processing on a session specific basis to reduce interference between replayed updates associated with one active user session and network operations initiated during another active user session. For example, the engine manager 124 can assign different target engines 106 or differently configured instances of a target engine 106 to different active user sessions, such that the target engines 106 can process replayed updates in a session isolated manner. Such an arrangement can improve coordination between delayed data mutations or updates and real-time network operations, while the data processing system 102 can support scalable reconstruction of application state across multiple concurrent sessions. In certain cases, the engine manager 124 can limit replay retrieval and replay processing to session relevant updates to reduce replay latency for high volume CDC streams, such as streams carrying 100, 1,000, 10,000, 50,000, or more update events per minute, by reducing processing of unrelated update events.

The engine manager 124 can manage the execution and resource allocation of target engines 106. The engine manager 124 can actively monitor active user sessions and their associated source applications 104 to maintain an up-to-date view of the workload distribution. The engine manager 124 can also monitor the performance and health of target engines 106 based on metrics such as CPU usage, memory consumption, replay latency (the time it takes to replay an update), and error rates. Based on these metrics, the engine manager 124 can detect performance issues. The engine manager 124 can provide control functions that allow administrators to manage target engines 106. For example, administrators can start, stop, pause, or reconfigure individual target engines 106 for maintenance, troubleshooting, or performance tuning.

The engine manager 124 can implement horizontal and vertical scaling strategies to manage resource utilization effectively. For horizontal scaling, the engine manager 124 can initiate additional target engines 106 when resource utilization metrics exceed a defined utilization threshold. Resource utilization can refer to the measurement of how efficiently system resources, such as CPU, memory, storage, and network bandwidth, are being used by target engines 106 during their operation. Horizontal scaling can be relevant when managing increased workload demands from real-time data streams or recorded batch processing operations. The engine manager 124 can then distribute the increased workload across multiple target engines 106 to maintain responsiveness and prevent performance degradation. The engine manager 124 can also redistribute the workload among existing target engines 106 (including the newly added ones) to balance the load and prevent overloading any single target engine 106. For vertical scaling, the engine manager 124 can dynamically adjust resource allocation to individual target engines 106 based on their real-time resource demands. For example, target engines 106 experiencing higher resource utilization due to real-time or batch processing can receive additional resources (e.g., increased CPU or memory allocation) to facilitate efficient processing, while resources can be reclaimed from underutilized target engines 106 and reallocated as needed. In certain cases, the engine manager 124 can dynamically adjust resource allocation among a plurality of target engines 106 by reallocating resources from one or more underutilized target engines 106 to one or more target engines 106 having resource utilization exceeding the utilization threshold (e.g., 60%, 70%, 80%, 90%, or more CPU, memory, storage, or network utilization).

The engine manager 124 can incorporate fault tolerance mechanisms to maintain the continuous operation of replay processes. The engine manager 124 can monitor the operating system processes associated with each target engine 106. If a target engine 106 process terminates unexpectedly or becomes unresponsive, the engine manager 124 detects the failure through health checks. For example, the engine manager 124 can send test requests to the target engine 106 and monitor for valid responses within a predefined time frame. If the target engine 106 fails to respond, returns an error, or exhibits process termination, the engine manager 124 can flag the target engine 106 as failed. The engine manager 124 can monitor performance metrics (CPU usage, memory consumption, etc.). A sudden drop in performance or a spike in error rates can indicate a problem. Upon detecting a failure, the engine manager 124 can initiate corrective actions to minimize disruption. For example, the engine manager 124 can automatically restart the failed target engine 106 or reallocate the workload (e.g., replay tasks) previously assigned to the failed target engine 106 to another available target engine 106.

The data processing system 102 can include, interface with, communicate with, or otherwise utilize an interface controller 126. The interface controller 126 can be or include any script, file, program, application, set of instructions, or computer-executable code that can facilitate communication among the data processing system 102, the source application 104, the target engine 106, and the data source 108. The interface controller 126 can include hardware, software, or any combination thereof. The interface controller 126 can facilitate communication among the data processing system 102, the source application 104, the target engine 106, and the data source 108 via one or more communication interfaces. A communication interface can include, for example, an application programming interface (“API”) compatible with a particular component of the data processing system 102, the source application 104, the target engine 106, and the data source 108. The communication interface can provide a particular communication protocol compatible with a particular component of the data processing system 102, a particular component of the source application 104, a particular component of the target engine 106, or a particular component of the data source 108. The interface controller 126 can be compatible with particular content objects and can be compatible with particular content delivery systems corresponding to particular content objects, structures of data, types of data, or any combination thereof. For example, the interface controller 126 can be compatible with the transmission of structured or unstructured data according to one or more metrics.

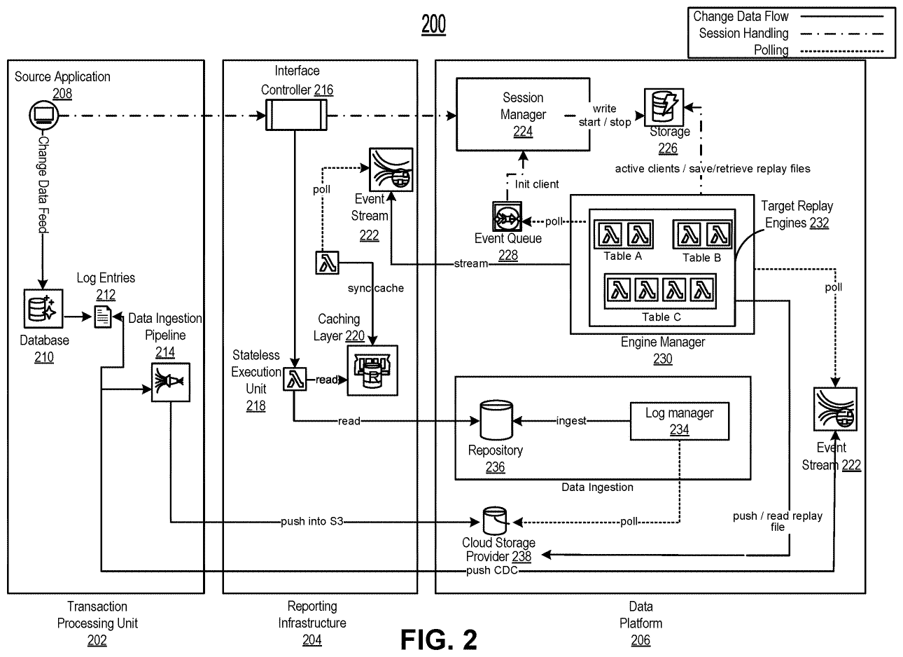

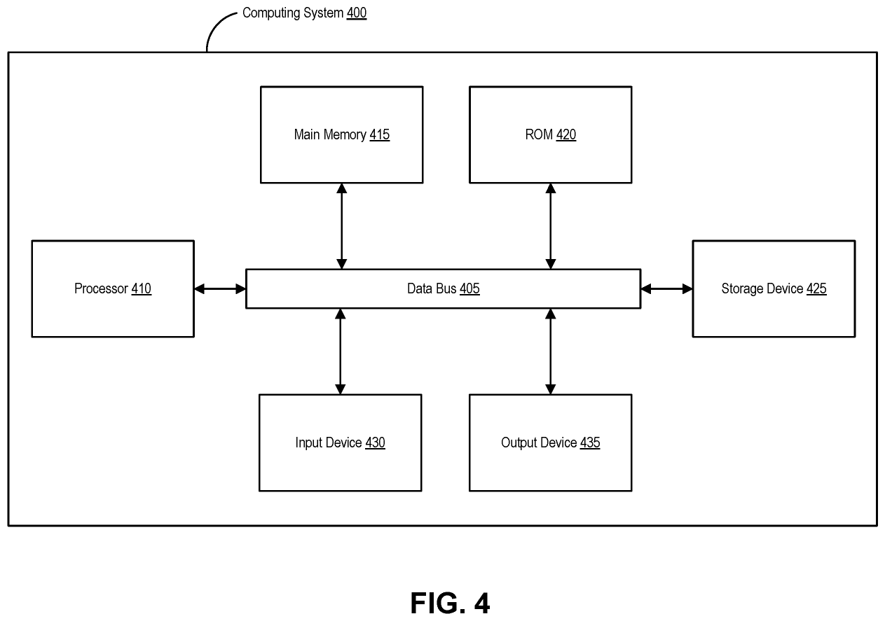

FIG. 2 depicts an example operational system 200, according to one or more aspects of the technical solutions described herein. As illustrated by way of example in FIG. 2, the operational system 200 can include at least a transaction processing unit 202, a reporting infrastructure 204, and a data platform 206. Various components of the system 200 shown in FIG. 2 may be similar to, and include any of the structure and functionality of, the system 100 of FIG. 1. The operational system 200 can be performed by one or more systems or components depicted in FIG. 1 or FIG. 4. In FIG. 2, solid lines can represent change data flow, dashed lines can represent session handling communications, and dotted lines can represent polling operations.

The transaction processing unit 202 can receive interactions from a front-end client via a client device executing a source application 208. The transaction processing unit 202 can initiate operations to update data records stored in a database 210. The system 200 can provide a change data feed corresponding to such data updates. The change data feed can include log entries 212 (e.g., transaction log entries) or other indications of changes to the data records stored in the database 210. The change data feed, including the log entries 212, can be streamed using a data ingestion pipeline 214, which can operate within a containerized execution environment to provide near real-time updates to the downstream systems. Such change data flow can include transmission of the log entries 212 and other data updates among the database 210, the data ingestion pipeline 214, the cloud-based storage provider 238, and downstream replay related components. The data ingestion pipeline 214 can additionally flush, store, or persist the log entries 212 in a cloud-based storage provider 238 at periodic intervals (e.g., every 60 minutes) to support batch ingestion workflows or archival storage.

The reporting infrastructure 204 can facilitate communication between the transaction processing unit 202 and components of the data platform 206. Within the reporting infrastructure 204, an interface controller 216 (e.g., an application routing gateway) can forward, provide, or transmit requests to appropriate services and can interface with a stateless execution unit 218 (e.g., implemented using serverless functions). The stateless execution unit 218 can comprise a request receiver or a session manager to perform intermediate processing of incoming data. The stateless execution unit 218 can cache relevant metadata in an in-memory caching layer 220. The serverless functions can be invoked in response to events delivered via an event stream 222 (e.g., a streaming data service) to facilitate near real-time and scalable operation. In certain cases, one or more components of the operational system 200 can periodically poll event streams, queues, or storage resources to determine whether data, events, or replay files are available for processing. The reporting infrastructure 204 can form part of a cloud native, serverless, and scalable architecture to support on-demand processing.

The data platform 206 can include a stateless backend service that can expose a session management interface (e.g., a session manager 224) via an API. Upon detecting a session initiation event, the session manager 224 can store metadata, such as a session start time and a source application identifier, in a key-value storage 226. The session related information can be communicated among the source application 208, the session manager 224, the key-value storage 226, and the engine manager 230, among others, to coordinate replay operations during an active user session. Such session handling communications can include, for example, session initiation, session start or stop updates, session state updates, and retrieval or storage of session related replay information, among others. The log entries 212 from the database 210 (e.g., after initial processing by the data ingestion pipeline 214 or being enqueued into a session log event queue 228) can be accessed, retrieved, and filtered by a log selector before reaching the engine manager 230. Such log selection and filtering processes can be performed based on the session context, such as timestamps or identifiers matching the source application, as part of a preparatory phase in which an engine manager 230 activates one or more target replay engines 232. Based on this filtered subset, the engine manager 230 can select and initiate one or more target replay engines 232, which can transmit the relevant updates back to the source application 208 via the reporting infrastructure 204. The replay engine 232 can present the data updates made to data records during an active session such that the source application 208 can synchronize its state through replay.

The engine manager 230 can detect when the number of active user sessions exceeds a threshold (e.g., 50, 100, 500, or more active user sessions) or when resource utilization exceeds a predefined threshold (e.g., 60%, 70%, 80%, 90%, or more of CPU, memory, or network utilization). Based on such conditions, the engine manager 230 can dynamically allocate or scale additional target replay engines 232 to maintain performance. A log manager 234 within the data platform 206 can coordinate with the data ingestion pipeline 214 to store structured logs in an analytics repository 236. Such configurations can support near real-time and batch processing for replay workflows. Additionally, the cloud-based storage provider 238 can function as the source of input mapping files and the destination for replay output files and archival data.

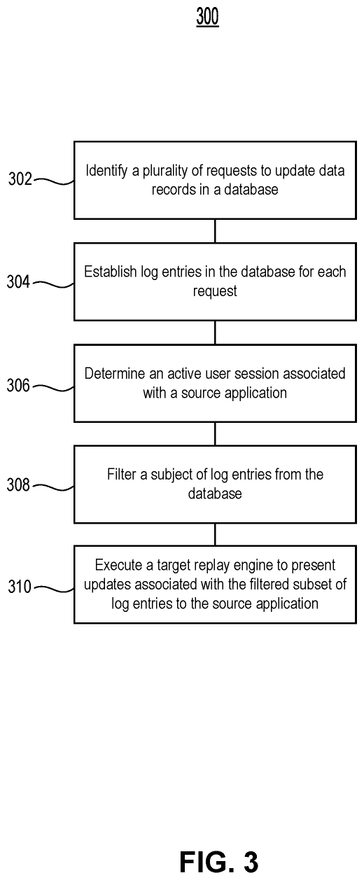

FIG. 3 depicts a method 300 of synchronizing application states for executing network operations. The method 300 can be implemented using a system 100, 200, 400, or any other features discussed in FIG. 1, FIG. 2, or FIG. 4. The method can include operations 302-310. The operations 302-310 can be executed in any order or sequence.

At 302, the method 300 can include identifying a plurality of requests to update data records in a database. The method can include identifying the plurality of requests to update one or more data records, where the update can include at least one of a generation, a modification, or a deletion of the one or more data records. Each request can include an identifier of a source application. Each request can update a respective data record at a second timestamp, which can be subsequent to a first timestamp at which the update was applied to the respective data record. The method can include receiving the plurality of requests via a real-time data source.

At 304, the method 300 can include establishing log entries in the database for each request. Each log entry can include a timestamp corresponding to a respective request and an identifier of the source application. The method can include establishing each log entry based on the timestamp corresponding to receipt of the respective request. The method can include establishing each log entry based on the timestamp corresponding to the initiation of the respective request by the source application. The method can include storing the log entries in a cloud-based storage system.

At 306, the method 300 can include determining an active user session associated with a source application. The method can include determining the active user session associated with a session start time. The method can include determining the active user session via a login application programming interface.

At 308, the method 300 can include filtering a subset of log entries from the database. The method can include filtering the subset of log entries, where each log entry of the subset of log entries includes a timestamp prior to the session start time and an identifier that matches the source application. The method can include filtering the subset of log entries, where each log entry of the subset of log entries includes an identifier that matches the source application and a timestamp within a predetermined relationship to the session start time.

At 310, the method 300 can include executing a target replay engine to present updates associated with the filtered subset of log entries to the source application. The method can include executing the target replay engine to provide, to the source application, during the active user session, updates associated with the subset of log entries. Such updates can cause the source application to perform a network operation. The method can include selecting the target replay engine for the active user session based on the identifier of the source application. The source application can be identified as the one associated with the active user session or with the requests. The method can include determining a plurality of active user sessions associated with the source application based on a plurality of indications, where each of the plurality of indications can correspond to a respective active user session. The method can include executing a plurality of target replay engines, where each target replay engine can provide, to the source application associated with a respective active user session, the updates associated with a respective subset of log entries. The method can include executing the plurality of target replay engines based on a number of active user sessions exceeding a threshold. The method can include executing the plurality of target replay engines based on resource utilization associated with at least one target replay engine exceeding a utilization threshold. The method can include dynamically adjusting resource allocation among the plurality of target replay engines based on the resource utilization associated with the at least one target replay engine exceeding the utilization threshold.

FIG. 4 depicts a block diagram of a computing system 400 for implementing the embodiments of the technical solutions discussed herein, in accordance with various aspects. FIG. 4 illustrates a block diagram of an example computing system 400, which can also be referred to as the computer system 400. Computing system 400 can be used to implement elements of the systems and methods described and illustrated herein. Computing system 400 can be included in and run any device (e.g., a server, a computer, a cloud computing environment, or a data processing system).

Computing system 400 can include at least one bus data bus 405 or other communication device, structure, or component for communicating information or data. Computing system 400 can include at least one processor 410 or processing circuit coupled to the data bus 405 for executing instructions or processing data or information. Computing system 400 can include one or more processors 410 or processing circuits coupled to the data bus 405 for exchanging or processing data or information along with other computing systems 400. Computing system 400 can include one or more main memories 415, such as a random access memory (RAM), dynamic RAM (DRAM), cache memory or other dynamic storage device, which can be coupled to the data bus 405 for storing information, data and instructions to be executed by the processor(s) 410. Main memory 415 can be used for storing information (e.g., data, computer code, commands, or instructions) during execution of instructions by the processor(s) 410.

Computing system 400 can include one or more read only memories (ROMs) 420 or other static storage device 425 coupled to the bus 405 for storing static information and instructions for the processor(s) 410. Storage devices 425 can include any storage device, such as a solid-state device, magnetic disk, or optical disk, which can be coupled to the data bus 405 to persistently store information and instructions.

Computing system 400 can be coupled via the data bus 405 to one or more output devices 435, such as speakers or displays (e.g., liquid crystal display or active matrix display) for displaying or providing information to a user. Input devices 430, such as keyboards, touch screens or voice interfaces, can be coupled to the data bus 405 for communicating information and commands to the processor(s) 410. Input device 430 can include, for example, a touch screen display (e.g., output device 435). Input device 430 can include a cursor control, such as a mouse, a trackball, or cursor direction keys, for communicating direction information and command selections to the processor(s) 410 for controlling cursor movement on a display.

The processes, systems and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors 410 in a multi-processing arrangement can also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter, including the operations described in this specification, can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the technology described herein. While aspects of the technical solutions described herein have been described with reference to an exemplary embodiment, it is understood that the words which have been used herein are words of description and illustration, rather than words of limitation. Changes can be made, within the purview of the appended claims, as presently stated and as amended, without departing from the scope and spirit of the technology described herein in its aspects. Although aspects of the technical solutions described herein have been described herein with reference to particular means, materials and embodiments, the present description is not intended to be limited to the particulars described herein; rather, the present description extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media, and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements, and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present description.

What is claimed is:

1. A system of synchronizing application states for executing network operations, the system comprising:
one or more processors, coupled with memory, to:
identify a plurality of requests to update one or more data records in a database, each request including an identifier of a source application and the each request being to update a respective data record at a second timestamp, the second timestamp being subsequent to a first timestamp at which the update was applied to the respective data record;
establish, in the database, log entries for the plurality of requests, each log entry comprising:
a timestamp corresponding to a respective request; and
the identifier of the source application;
determine an active user session associated with the source application, the active user session associated with a session start time;
select, from the database, a subset of log entries from a plurality of log entries, each log entry of the subset of log entries having the timestamp prior to the session start time and the identifier matching the source application; and
execute a target replay engine to provide, to the source application, during the active user session, updates associated with the subset of log entries to cause the source application to perform a network operation based on the updates.

2. The system of claim 1, wherein the one or more processors further:
establish each log entry based on the timestamp corresponding to receipt of the respective request.

3. The system of claim 1, wherein the one or more processors further:
establish each log entry based on the timestamp corresponding to initiation of the respective request by the source application.

4. The system of claim 1, wherein the update includes at least one of a generation, a modification, or a deletion of the respective data record.

5. The system of claim 1, wherein the one or more processors further:
select the target replay engine for the active user session based on the identifier of the source application.

6. The system of claim 1, wherein the one or more processors further:
determine a plurality of active user sessions associated with the source application based on a plurality of indications, each of the plurality of indications corresponding to a respective active user session; and
execute a plurality of target replay engines, each target replay engine to provide, to the source application associated with the respective active user session, the updates associated with a respective subset of log entries.

7. The system of claim 6, wherein the one or more processors further:
execute the plurality of target replay engines based on a number of active user sessions exceeding a threshold.

8. The system of claim 6, wherein the one or more processors further:
execute the plurality of target replay engines based on resource utilization associated with at least one target replay engine exceeding a utilization threshold.

9. The system of claim 8, wherein the one or more processors further:
dynamically adjust resource allocation among the plurality of target replay engines based on the resource utilization associated with the at least one target replay engine exceeding the utilization threshold.

10. The system of claim 1, wherein the one or more processors further:
determine the active user session via a login application programming interface.

11. The system of claim 1, wherein the one or more processors further:
receive the plurality of requests via a real time data source.

12. The system of claim 1, wherein the one or more processors further:
store the log entries in a cloud-based storage system.

13. A method for synchronizing application states for executing network operations, the method comprising:
identifying, by one or more processors, coupled with memory, a plurality of requests to update one or more data records in a database, each request including an identifier of a source application;
establishing, by the one or more processors, in the database, log entries for the plurality of requests, each log entry comprising:
a timestamp corresponding to a respective request; and
the identifier of the source application;
determining, by the one or more processors, an active user session associated with the source application, the active user session associated with a session start time;
filtering, by the one or more processors, from the database, a subset of log entries, each log entry of the subset of log entries having the timestamp prior to the session start time and the identifier matching the source application; and
executing, by the one or more processors, a target replay engine to present updates associated with the subset of log entries to cause the source application to perform, during the active user session, a network operation.

14. The method of claim 13, further comprising:
establishing, by the one or more processors, each log entry based on the timestamp corresponding to receipt of the respective request.

15. The method of claim 13, further comprising:
establishing, by the one or more processors, each log entry based on the timestamp corresponding to initiation of the respective request by the source application.

16. The method of claim 13, wherein the update includes at least one of a generation, a modification, or a deletion of the respective data record.

17. The method of claim 13, further comprising:
selecting, by the one or more processors, the target replay engine for the active user session based on the identifier of the source application.

18. The method of claim 13, further comprising:
determining, by the one or more processors, a plurality of active user sessions associated with the source application based on a plurality of indications, each of the plurality of indications corresponding to a respective active user session; and
executing, by the one or more processors, a plurality of target replay engines, each target replay engine to provide, to the source application associated with the respective active user session, the updates associated with a respective subset of log entries.

19. The method of claim 18, further comprising:
executing, by the one or more processors, the plurality of target replay engines based on a number of active user sessions exceeding a threshold.

20. A non-transitory computer readable medium including one or more instructions stored thereon and executable by a processor to:
identify a plurality of requests to update one or more data records in a database, each request including an identifier of a source application and the each request being to update a respective data record;
establish, in the database, log entries for the plurality of requests, each log entry comprising:
a timestamp corresponding to a respective request; and
the identifier of the source application;
determine an active user session associated with the source application, the active user session associated with a session start time;
select, from the database, a subset of log entries from a plurality of log entries, each log entry of the subset of log entries having the identifier matching the source application and having the timestamp within a predetermined relationship to the session start time; and
execute a target replay engine to provide, to the source application, updates associated with the subset of log entries to cause the source application to perform a network operation based on the updates.
